(19) United States
(12) Patent Application Publication
(10) Pub. No.: US 2013/0312088 A1
(43) Pub. Date: Nov. 21, 2013

(54) ELECTRONIC DEVICE AND METHOD FOR MANAGING ACCOUNTS AND PASSWORDS OF APPLICATION SYSTEMS

(71) Applicants: Hong Fu Jin Precision Industry (Shenzhen) Co., Ltd., (US); HON HAI PRECISION INDUSTRY CO., LTD., New Taipei (TW)

(72) Inventor: WEN-HUI ZHANG, Shenzhen (CN)

(73) Assignees: Hon Hai Precision Industry Co., Ltd., New Taipei (TW); Hong Fu Jin Precision Industry (Shenzhen) Co., Ltd, Shenzhen (CN)

(21) Appl. No.: 13/875,328

(22) Filed: May 2, 2013

(30) Foreign Application Priority Data
May 18, 2012 (CN) 2012101545868

(51) Int. Cl. G06F 21/32

(52) U.S. Cl. CPC G06F 21/32
USPC 726/19

(57) ABSTRACT

In a method for managing accounts and passwords of an application system using an electronic device, the method controls a fingerprint recognizing unit of the electronic device to capture a second fingerprint if a first fingerprint is stored in a storage device of the electronic device, and displays a login interface of the application system on a display screen of the computing device if the second fingerprint is the same with the first fingerprint. The method obtains the account and password of the application system from the storage device if the account and password of the application system is stored in the storage device, and inputs the account and password into two inputting boxes of the login interface of the application system.

### BACKGROUND

1. Technical Field

The embodiments of the present disclosure relate to security management systems and methods, and more particularly to an electronic device and a method for managing accounts and passwords of an application system.

2. Description of Related Art

In recent years, many application systems, such as an online banking payment system, are more and more popular. However, it is very inconvenient for people to remember accounts and passwords of so many application systems. Therefore, there is a need for an improved system and method for managing such many accounts and passwords of the application system.

### BRIEF DESCRIPTION OF THE DRAWINGS

FIG. 1 is a block diagram of one embodiment of an electronic device including an account and password management system.

FIG. 2 is a block diagram of one embodiment of a running environment of the account and password management system in the FIG. 1.

FIG. 3 is a block diagram of one embodiment of function modules of the account and password management system in FIG. 1.

FIG. 4 is a flowchart of one embodiment of a method for managing accounts and passwords of an application system.

FIG. 5 is a flowchart of one embodiment of block S202 of FIG. 3.

FIG. 6 is a flowchart of one embodiment of block S205 of FIG. 3.

FIG. 7 is a flowchart of one embodiment of making a copy of accounts and passwords of an application system.

### DETAILED DESCRIPTION

The present disclosure, including the accompanying drawings, is illustrated by way of examples and not by way of limitation. It should be noted that references to “an” or “one” embodiment in this disclosure are not necessarily to the same embodiment, and such references mean “at least one.”

In general, the word “module,” as used herein, refers to logic embodied in hardware or firmware, or to a collection of software instructions, written in a programming language. In one embodiment, the program language may be Java, C, or assembly. One or more software instructions in the modules may be embedded in firmware, such as in an EPROM. The modules described herein may be implemented as either software and/or hardware modules and may be stored in any type of non-transitory computer-readable medium or other storage device. Some non-limiting examples of non-transitory computer-readable media include CDs, DVDs, flash memory, and hard disk drives.

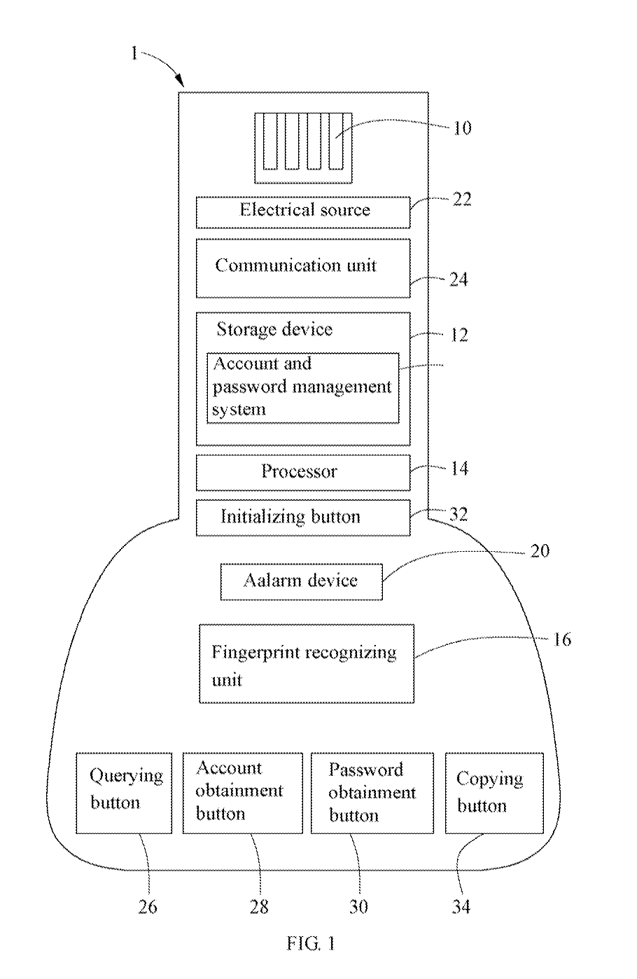

FIG. 1 is a block diagram of one embodiment of an electronic device 1 comprising an account and password management system 18. In the embodiment, the electronic device 1 may comprise a universal serial bus (USB) port 10, a storage device 12, at least one processor 14, a fingerprint recognizing unit 16, an alarm device 20, an electronic source 22, and a communication unit 24. The electronic device 1 may further comprise a querying button 26, an account obtainment button 28, a password obtainment button 30, an initializing button 32, and a copying button 34. The electronic device 1 may be a flash memory, or a unmovable hard drive, for example. The account and password management system 18 may include computerized codes or instructions that can be stored in the storage device 12.

The USB port 10 is a standard cable connection interface on the electronic device 1. As shown in FIG .2, the electronic device 1 connects to the computing device 2 through the USB port 10, and the communication unit 24 communicates with the computing device 2 through the USB port 10.

In one embodiment, the storage device 12 (non-transitory storage device) may be an internal storage system, such as a random access memory (RAM) for the temporary storage of information, and/or a read only memory (ROM) for the permanent storage of information. In some embodiments, the storage device 12 may be an external storage system, such as an external hard disk, a storage card, or a data storage medium.

The at least one processor 14 may include a processor unit, a microprocessor, an application-specific integrated circuit, and a field programmable gate array, for example.

The alarm device 20 generates an alarm, such as a voice alarm or a light alarm when a verification failure occurs in the electronic device 1. The verification failure is defined when a second fingerprint is not same with a first fingerprint. In the embodiment, the first fingerprint is one fingerprint of a user of the electronic device 1, and the first fingerprint is stored in the storage device 12 in advance. The second fingerprint is captured by the fingerprint recognizing unit 16 when the user operates the electronic device 1.

The electronic source 22 supplies power for the electronic device 1.

The querying button 26 is pressed to query whether an account and password of an application system is stored in the storage device 12. The application system may be an online banking payment system, for example. The application system is installed in the computing device 2.

The account obtainment button 28 and the password obtainment button 30 may be pressed to obtain the account and the password of the application system from the storage device 12, and to input the obtained account and password into two inputting boxes of a login interface of the application system.

The initializing button 32 may be pressed to make an initialization of the electronic device 1, if the first fingerprint is not stored in the storage device 12.

The copying button 34 may be pressed once to transport the account and password of the application system to the computing device 2, and is pressed twice to transport the account and password back to the electronic device 1.

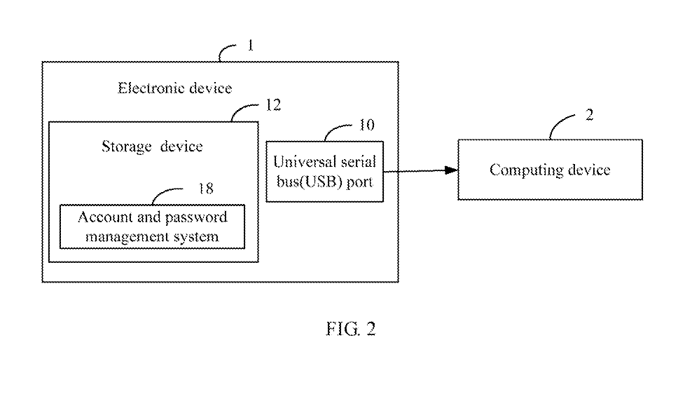

FIG. 2 is a block diagram of one embodiment of a running environment of the account and password management system 18 included in the electronic device 1. In the embodiment, the account and password management system 18 includes a plurality of function modules which include computerized codes or instructions that can be stored in the storage device 12 and executed by the at least one processor 14 to provide a method for managing account and password.

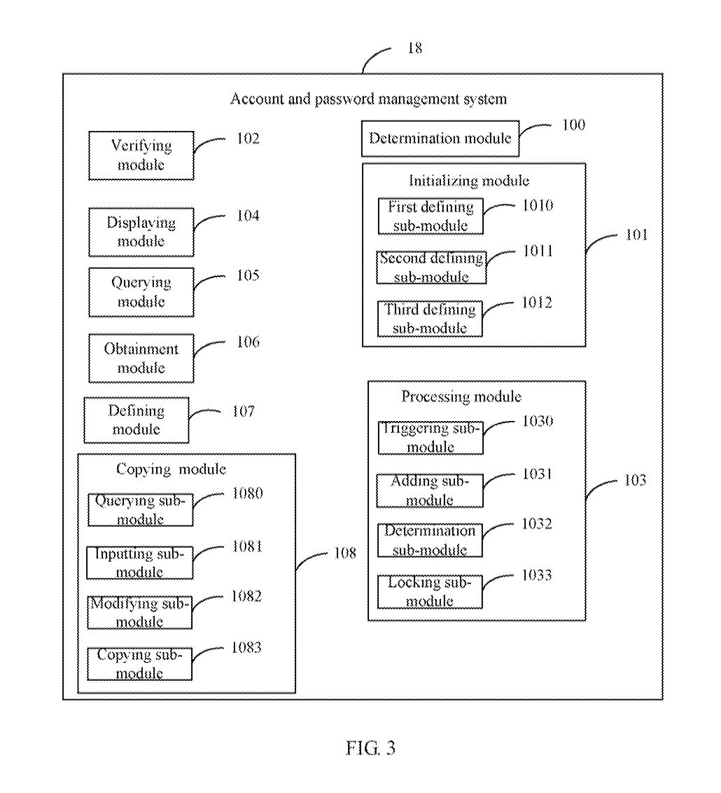

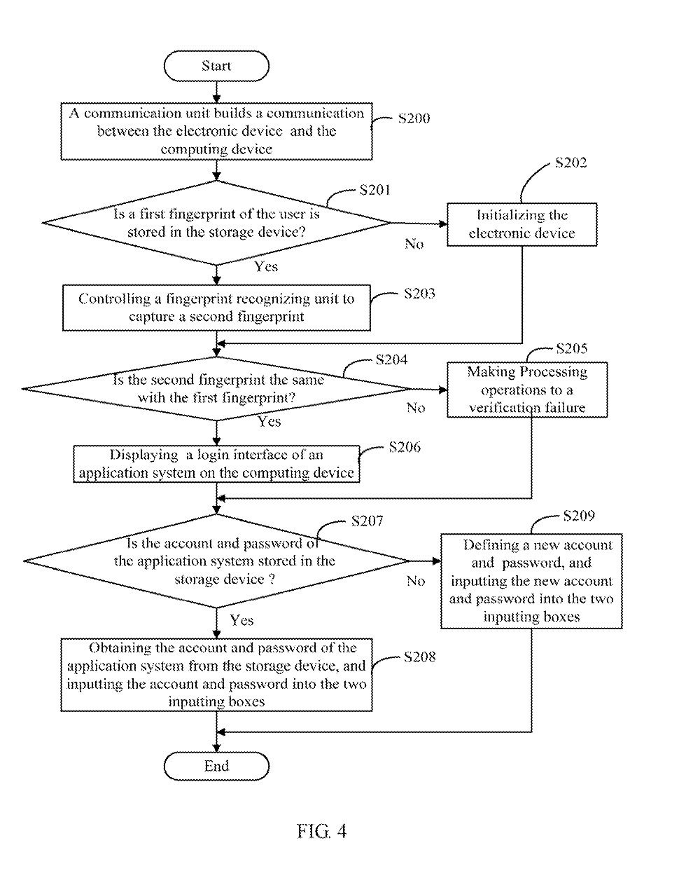

FIG. 3 is a block diagram of one embodiment of function modules of the account and password management system 18. In the embodiment, the account and password management system 10 may include a determination module 100, an initializing module 101, a verifying module 102, a processing module 103, a displaying module 104, a querying module 105, an obtainment module 106, and a defining module 107. In the embodiment, the initializing module 101 may comprise a first defining sub-module 1010, a second defining sub-module 1011, and a third defining sub-module 1012. The processing module 103 may comprises a triggering sub-module 1030, an adding sub-module 1031, a determination sub-module 1032, and a locking sub-module 1033. In the embodiment, the account and password management system 10 may further comprise a copying module 108. The copying module 108 may comprise a querying sub-module 1080, an inputting sub-module 1081, a modifying sub-module 1082, a copying sub-module 1083. The modules may comprise computerized codes in the form of one or more programs that are stored in the storage device 12 and executed by the at least one processor 14 to provide functions for implementing the modules. The functions of the function modules are illustrated in FIG. 4 and described below.

FIG. 4 illustrates a flowchart of one embodiment of a method for managing accounts and passwords of an application system using the electronic device 1. Depending on the embodiment, additional steps may be added, others removed, and the ordering of the steps may be changed.

In block S200, the communication unit 24 builds an electronic communication between the electronic device 1 and the computing device 2 when the electronic device 1 is connected to the computing device 2 through the USB port 10.

In block S201, the determination module 100 determines whether a first fingerprint of the user is stored in the storage device 12. If the first fingerprint is stored in the storage device 12, block S203 is implemented. Otherwise, if the first fingerprint is not stored in the storage device 12, block S202 is implemented.

In block S202, the initializing module 101 initializes the electronic device 1 when the initializing button 32 is pressed.

In block S203, the verifying module 102 controls the fingerprint recognizing unit 16 to capture a second fingerprint of the user when the user operates the electronic device 1.

In block S204, the verifying module 102 determines a verification whether the second fingerprint is the same with the first fingerprint. If the second fingerprint is the same with the first fingerprint, block S206 is implemented. If the second fingerprint is not the same with the first fingerprint, block S205 is implemented.

In block S205, the processing module 103 processes a verification failure that the second fingerprint is not the same with the first fingerprint.

In block S206, the displaying module 104 displays the login interface of the application system on a display screen of the computing device 2. The login interface comprises two inputting boxes for inputting the account and the password of the application system.

In block S207, the querying module 105 queries whether the account and the password of the application system are stored in the storage device 12 when the querying button 26 is pressed. If the account and the password of the application system are stored in the storage device 12, block S208 is implemented. Otherwise, if the account and password of the application system are not stored in the storage device 12, block S209 is implemented.

In block S208, the obtainment module 106 obtains the account and the password of the application system from the storage device 12 when the account obtainment button 28 and the password obtainment button 30 are pressed, and receives the obtained account and password into the two inputting boxes of the log-in interface of the application system.

In block S209, the defining module 107 defines a new account and a new password of the application system, and receives the new account and password into the two inputting boxes the log-in interface of the application system, and stores the new account and password in the storage device 12.

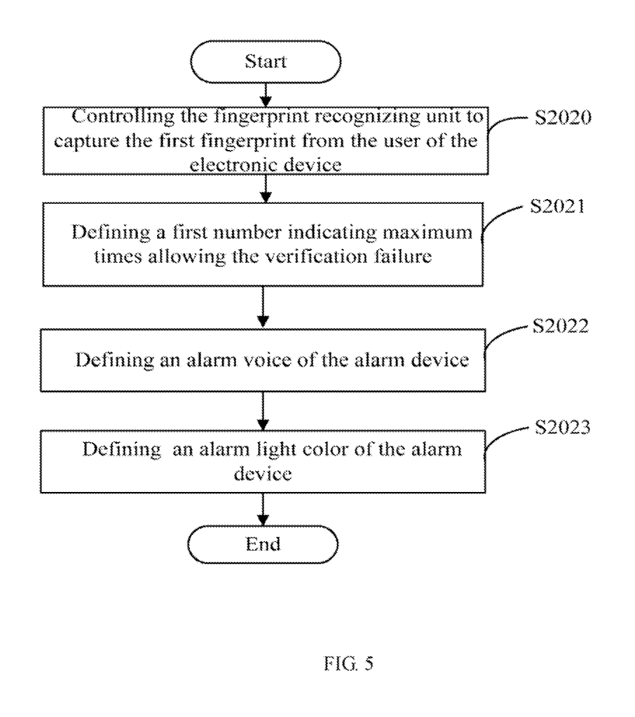

FIG. 5 illustrates a flowchart of one embodiment of the block S202. Depending on the embodiment, additional steps may be added, others removed, and the ordering of the steps may be changed.

In block S2020, the first defining sub-module 1010 controls the fingerprint recognizing unit 16 to capture the first fingerprint from the user of the electronic device 1, and stores the first fingerprint in the storage device 12.

In block S20, the first defining sub-module 1011 defines a first number indicating maximum times allowing the verification failure.

In block S2022, the second defining sub-module 1012 defines a voice alarm and a light alarm of the alarm device 20.

In block S2023, the third defining sub-module 1013 defines an alarm light color of the alarm device 20.

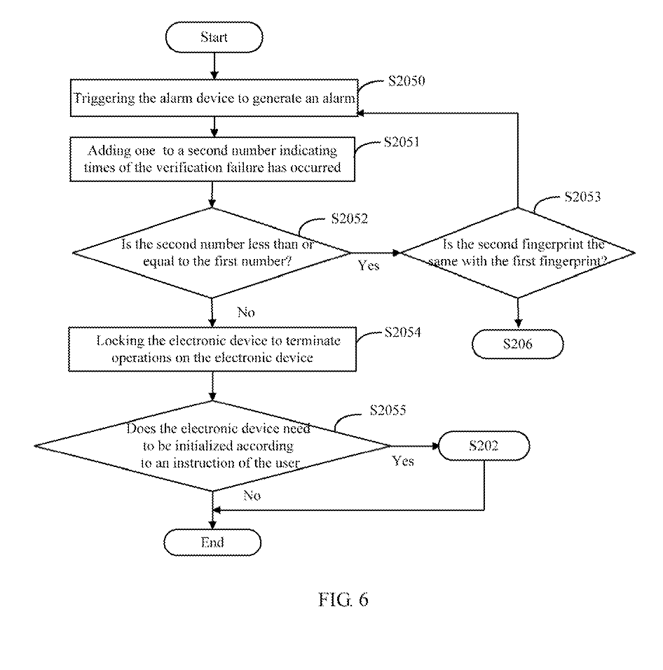

FIG. 6 illustrates a flowchart of one embodiment of the block S205. Depending on the embodiment, additional steps may be added, others removed, and the ordering of the steps

In block S2050, the triggering sub-module 1030 triggers the alarm device 20 to generate an alarm when the verification failure occurs in the electronic device 1.

In block S2051, the adding sub-module 1031 adds one to a second number indicating times of the verification failure has occurred.

In block S2052, the determination sub-module 1032 determines whether the second number is less than or equal to the first number. If the second number is less than or equal to the first number, block S2053 is implemented. Otherwise, if the second number is more than the first number, block S2054 is implemented.

In block S2053, the verifying sub-module 102 determines the verification whether the second fingerprint is the same with the first fingerprint. If the second fingerprint is the same with the first fingerprint, block S206 is implemented. If the second fingerprint is not the same with the first fingerprint, block S2050 is implemented.

In block S2054, the locking sub-module 1033 locks the electronic device 1 to terminate the operation of the electronic device 1.

In block S2055, the determination sub-module 1034 determines whether the electronic device needs to be initialized according to an instruction of the user of the electronic device. If the electronic device needs to be initialized, block S202 is implemented, Otherwise, if the electronic device does not need to be initialized, the procedure ends.

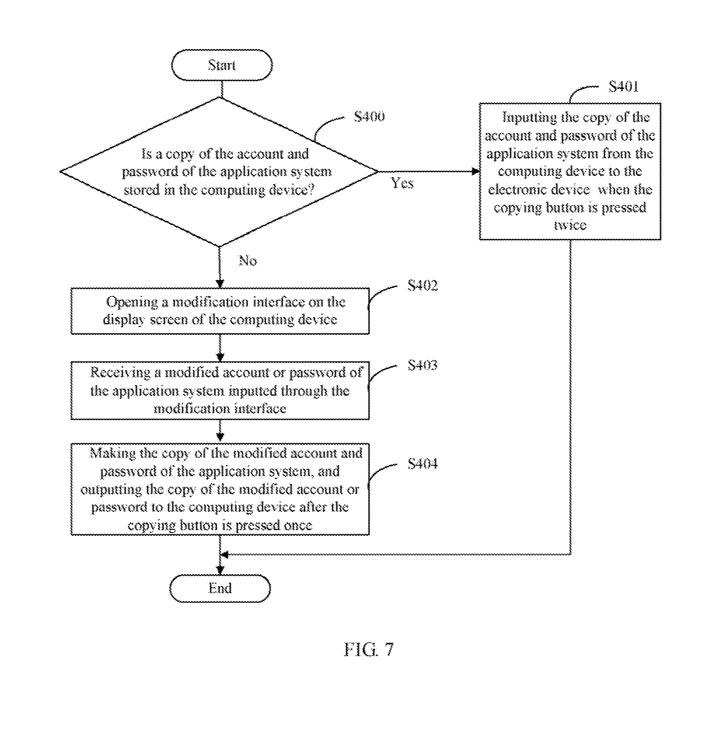

The method for managing account and password may further comprises a flowchart of making a copy of accounts and passwords of an application system. FIG. 7 illustrates the flowchart of making a copy of accounts and passwords of an application system. Depending on the embodiment, additional steps may be added, others removed, and the ordering of the steps.

In block S400, the querying sub-module 1080 queries whether a copy of the account and password of the application system are stored in the computing device 2 connecting to the electronic device 1 when the copying button 34 is pressed twice. If the copy of the account and password are stored in the computing device 2, block S401 is implemented. If the copy of the account and password are not stored in the computing device 2, block S402 is implemented.

In block S401, the inputting sub-module 1081 inputs the copy of the account and password of the application system from the computing device 2 to the electronic device 1 when the copying button 34 is pressed twice.

In block S402, the modifying sub-module 1082 opens a modification interface on the display screen of the computing device 1.

In block S403, the modifying sub-module 1082 receives a modified account or password of the application system inputted through the modification interface.

In block S404, the copying sub-module 1083 makes the copy of the modified account and password of the application system, and outputs the copy of the modified account or password to the computing device 2 when the copying button 34 is pressed once.

Although certain disclosed embodiments of the present disclosure have been specifically described, the present disclosure is not to be construed as being limited thereto. Various changes or modifications may be made to the present disclosure without departing from the scope and spirit of the present disclosure.

What is claimed is:

1. An electronic device electronically connected to a computing device, the electronic device comprising:
an alarm device;
a fingerprint recognizing unit;
an initializing button;
an account obtainment button;
a password obtainment button;
a querying button; and
one or more programs stored in a storage device and executed by at least one processor, the one or more programs comprising:
a determination module that determines whether a first fingerprint of a user of the electronic device is stored in the storage device;
an initializing module that initializes the electronic device when the initializing button is pressed if the first fingerprint is not stored in the storage device;
a verifying module that controls the fingerprint recognizing unit to capture a second fingerprint of the user if the first fingerprint is stored in the storage device, and determines a verification whether the second fingerprint is the same with the first fingerprint;
a processing module that makes processing operations to a verification failure if the second fingerprint is not the same with the first fingerprint;
a displaying module that displays a login interface of the application system on a display screen of the computing device, wherein the login interface comprises two inputting boxes for inputting the account and the password of the application system;
a querying module that queries whether the account and the password of the application system are stored in the storage device when the querying button is pressed;
an obtainment module that obtains the account and the password of the application system from the storage device when the account obtainment button and the password obtainment button are pressed, and inputs the obtained account and password into the two inputting boxes of the login interface of the application system, if the account and the password of the application system are stored in the storage device; and
a defining module that defines a new account and a new password of the application system, inputs the new account and password into the two inputting boxes of the log-in interface of the application system, and stores the new account and password in the storage device, if the account and the password of the application system are not stored in the storage device.

2. The electronic device according to claim 1, wherein the initializing module further comprises:
a first defining sub-module that controls the fingerprint recognizing unit to capture the first fingerprint from the user of the electronic device, and stores the first fingerprint in the storage device, and defines a first number indicating maximum times allowing the verification failure;
a second defining sub-module that defines an alarm voice of the alarm device; and
a third defining sub-module that defines an alarm light color of the alarm device.

3. The electronic device according to claim 2, wherein the processing module further comprises:
a triggering sub-module that triggers the alarm device to generate an alarm when the verification failure occurs in the electronic device;
an adding sub-module that adds one to a second number indicating times of the verification failure has occurred in the electronic device; and
a locking sub-module that locks the electronic device to terminate the operation of the electronic device if the second number is more than the first number.

4. The electronic device according to claim 1, wherein the electronic device further comprises a communication unit that builds a communication between the electronic device and the computing device when the electronic device is connected to the computing device through a USB port.

5. A method for managing accounts and passwords of an application system using an electronic device of a computer device, the method comprising steps of:
(a) determining whether a first fingerprint of a user of the electronic device is stored in a storage device of the electronic device;
(b) initializing the electronic device when an initializing button of the electronic device is pressed if the first fingerprint is not stored in the storage device;
(c) controlling a fingerprint recognizing unit of electronic device to capture a second fingerprint of the user if the first fingerprint is stored in the storage device, and determining a verification whether the second fingerprint is the same with the first fingerprint;
(d) makes processing operations to a verification failure if the second fingerprint is not the same with the first fingerprint;
(e) displaying a login interface of the application system on a display screen of the computing device, wherein the login interface comprises two inputting boxes for inputting the account and the password of the application system;
(f) querying whether the account and the password of the application system are stored in the storage device when the querying button of the electronic device is pressed;
(g) obtaining the account and the password of the application system from the storage device when an account obtainment button and a password obtainment button of the electronic device are pressed, and inputting the obtained account and password into the two inputting boxes of the login interface of the application system, if the account and the password of the application system are stored in the storage device; and
(h) defining a new account and a new password of the application system, inputting the new account and password into the two inputting boxes of the log-in interface of the application system, and storing the new account and password in the storage device, if the account and the password of the application system are not stored in the storage device.

6. The method according to claim 5, wherein step (b) further comprises:
(b1) controlling the fingerprint recognizing unit to capture the first fingerprint from the user of the electronic device, and storing the first fingerprint in the storage device, and defining a first number indicating maximum times allowing the verification failure;
(b2) defining an alarm voice of the alarm device; and
(b3) defining an alarm light color of the alarm device.

7. The method according to claim 5, wherein step (d) further comprises:
(d1) triggering the alarm device to generate an alarm when the verification failure occurs in the electronic device;
(d2) adding one to a second number indicating times of the verification failure has occurred in the electronic device; and
(d3) locking the electronic device to terminate the operation of the electronic device if the second number is more than the first number.

8. The method according to claim 5, wherein the electronic device further comprises a communication unit that builds a communication between the electronic device and the computing device when the electronic device is connected to the computing device through a USB port.

9. A non-transitory computer-readable storage medium having stored thereon instructions being executed by a processor of a projector device, causes the electronic device to perform a method for managing accounts and passwords of an application system of a computer device, the method comprising:
(a) determining whether a first fingerprint of a user of the electronic device is stored in a storage device of the electronic device;
(b) initializing the electronic device when an initializing button of the electronic device is pressed if the first fingerprint is not stored in the storage device;
(c) controlling a fingerprint recognizing unit of electronic device to capture a second fingerprint of the user if the first fingerprint is stored in the storage device, and determining a verification whether the second fingerprint is the same with the first fingerprint;
(d) makes processing operations to a verification failure if the second fingerprint is not the same with the first fingerprint;
(e) displaying a login interface of the application system on a display screen of the computing device, wherein the login interface comprises two inputting boxes for inputting the account and the password of the application system;
(f) querying whether the account and the password of the application system are stored in the storage device when the querying button of the electronic device is pressed;
(g) obtaining the account and the password of the application system from the storage device when an account obtainment button and a password obtainment button of the electronic device are pressed, and inputting the obtained account and password into the two inputting boxes of the login interface of the application system, if the account and the password of the application system are stored in the storage device; and
(h) defining a new account and a new password of the application system, inputting the new account and password into the two inputting boxes of the log-in interface of the application system, and storing the new account and password in the storage device, if the account and the password of the application system are not stored in the storage device.

10. The storage medium according to claim 9, wherein step (b) further comprises:
(b1) controlling the fingerprint recognizing unit to capture the first fingerprint from the user of the electronic device, and storing the first fingerprint in the storage device, and defining a first number indicating maximum times allowing the verification failure;
(b2) defining an alarm voice of the alarm device; and
(b3) defining an alarm light color of the alarm device.

11. The storage medium according to claim 9, wherein step (d) further comprises:
(d1) triggering the alarm device to generate an alarm when the verification failure occurs in the electronic device;
(d2) adding one to a second number indicating times of the verification failure has occurred in the electronic device; and
(d3) locking the electronic device to terminate the operation of the electronic device if the second number is more than the first number.

12. The storage medium according to claim 9, wherein the electronic device further comprises a communication unit that builds a communication between the electronic device and the computing device when the electronic device is connected to the computing device through a USB port.
